(19) United States
(12) Patent Application Publication
(10) Pub. No.: US 2014/0017641 A1
(43) Pub. Date: Jan. 16, 2014

(54) Method and system for monitoring, verifying, measuring, reporting, rating and ranking company, industry and individual training, education, licensing, certification, or other trade, professional designations, or regulatory requirements.

(71) Applicant: David J. Nowacki, Dallas, TX (US)

(72) Inventor: David J. Nowacki, Dallas, TX (US)

(21) Appl. No.: 13/548,410

(22) Filed: Jul. 13, 2012

(51) Int. Cl. G09B 19/00

(52) U.S. Cl. 434/219

(57) ABSTRACT

The present invention relates to the method and system for monitoring, verifying, measuring and reporting an individual's past, current and/or required or elected training, formal or informal education, licensing, certification or other designations including regulatory requirements along with aggregating such reporting for any entity comprised of more than one individual such as a partnership, a company, a governmental body or agency, educational institution or a corporation. The present invention will collect and report professional continuing education credits or courses, OSHA or any/every other governmental agency's required continuing education, safety training, environmental training, and industry or trade group required continuing education. The present invention will report on individuals for their personal training activities, trainers and their qualifications in their delivering of training courses, training entities and that entity's qualifications, instructors and groups of individuals along with their qualifications.

### FIELD OF THE INVENTION

The present invention relates to a method and system for measuring overall training and education for individuals and for a collection of individuals forming entities. The present invention will measure and report the level of training and regulatory, industry or trade compliance requirements that an individual or any entity has at the current moment.

In one example (which example is intended to be illustrative and not restrictive), the method and system may be used to report that a mechanical subcontractor, employed at a nuclear facility, has not complied with recent OSHA compliances involving mandatory training for site workers and site management. The report may show that 60% of hourly workers are compliant with OSHA training and 30% of supervisory personnel are compliant with managerial OSHA certification.

In one example (which example is intended to be illustrative and not restrictive), the method and system may be used for tracking and reporting that senior finance and accounting staff at a publicly traded corporation do not have, individually and/or collectively, the necessary continuing education requirements for the CPA designation for those who currently hold an active CPA designation.

In one example (which example is intended to be illustrative and not restrictive), the method and system may be used for tracking and reporting that members of the board of directors at a publicly traded corporation do not have and have not completed the mandatory training in SEC regulations and Corporate Governance.

In one example (which example is intended to be illustrative and not restrictive), the method and system may be used for tracking and reporting that an individual has successfully completed a hazardous material handling course (required for his current job duties). Furthermore, this method and system will track the training entity and trainer, who delivered the hazardous material course or courses, and will evaluate and/or confirm that the trainer and training entity do have extensive experience and expertise in this field and that the course content is acceptable within that trade, occupation, profession, or governmental rules, laws or regulations.

### BACKGROUND OF THE INVENTION

Technological advances and complexities in society have created the need for more individuals to be specialists in order to accomplish various employment tasks. The specialization of jobs means more training both at a career's outset, but also throughout the decades for that individual. Training can originate from traditional education sources, such as 4-year colleges, junior colleges, trade schools and any number of other vendors in the for-profit or not-for-profit space. For professional positions, higher education is required such as law school, medical, dental, or veterinarian schools. Additionally, traditional trade schools provide intensive training in certain industry sectors such as arc-welding, plumbing, and automobile mechanics.

Non-traditional education is too broad of a topic to target any one field, industry, occupation or profession. However, these entities and institutions provide valuable training to individuals for the purpose of producing income and producing trained workforce.

Trade groups, industries and sectors in the economy are also developing certain levels of expertise to operate or work within the designated fields.

In many cases, individuals are being placed into jobs or employment situations where their actions and actions of other individuals or entities may result in direct or indirect harm to the consuming public. It is easy to point out that an airline pilot must go through many levels of training before they land a commercial aircraft. However, the training of the employee at the local brake shop is just as important to the car drivers who have used his/her services.

In addition, more regulations being adapted and adopted by governmental agencies, industry groups, trade groups and professions are attempting to create minimal standards. These standards might be comprised of ‘traditional’ degrees from secondary schools, colleges or universities and graduate schools. Other standards might be comprised of ‘non-traditional’ schools or training such as trade schools. Yet, the traditional and non-traditional education paths are being challenged through other delivery methods, other designations to include certificate programs including online classroom or training vendors.

Recent reports in trade publications have indicated 125 certificate, training or designation programs targeting the finance professional areas ranging from the insurance to mortgage to banking to securities to cash management activities. There comes into question the quality and compliance that may arise with the proliferation of such certificate programs. How can any consumer keep track of such a volume of designations in the financial services marketplace?

Trade groups, such as welders, electricians and other skilled laborers have many levels of regulatory, industry or trade requirements including OSHA and other safety programs. There are some specific industries that require a minimal number of hours training every 6 months.

There are two different issues to be addressed in the process and these depend on one's viewpoint. From a consumer's point of view, how can they ensure that contractors have the proper safety training if they are to hire someone for boiler replacement? The other view is from the worker' standpoint: How can he/she show and verify that they are compliant with current industry or governmental rules and have this verification be mobile or transferable to their next job, employer or contract?

The method and system of this current invention will track and deliver this timely information. This invention will provide the following (which example is intended to be illustrative and not restrictive),
Allow the individual to report successful training
Allow the trainer to confirm the individual successfully completed training (third party verification)
Verification that the trainer(s) and the course(s) delivered was/were, in fact, valid courses, with valid content and delivered by competent trainers.
With permission from the individual, report such training to other employers (job shops, for example), contractors or day-laborer events.
Allow the individual to report what firm they are currently employed.
Allow firms to aggregate all workers, reporting as above or not, to determine whether the firm is rated and ranked with the various individual scores in aggregate.

The invention provides numerous benefits to individuals, businesses and society in general. One way society will benefit is that this invention creates an independent third party who can objectively report safety training has been achieved by individuals and, collectively, entities which place consumers at risk through their actions. By not being affiliated with the trainer or training entity or with the actual trained person, this system creates that independent third party and can objectively report actions and activities of those who are trained or should have been trained.

Individuals who are in employment or career situations which tend to be transitory may be able to quickly and accurately report their required safety training is both valid and up to date. Similarly, employers using these individuals, collectively, can report the level of compliance at the employer level to any and all agencies that require such data, perhaps in real time.

Consumers can easily verify, through an independent unaffiliated entity, the level of successful training of individuals they employ at their home, for example, or the overall level of training at service providers such as an automobile brake repair shop.

Informed consumers may use this information to determine where to go for goods and services; similarly, entities providing goods and services may report to their customers and clients that they have, in fact, been trained and are current in their activities.

Firms with deficits in safety training, as one example, can take appropriate and timely steps to bring themselves up to compliance. This can be reported and updated in a real-time basis. Additionally, firms may be able to provide customers and consumers relative and absolute rankings as part of their marketing efforts to keep customers and secure new customers.

Benefits to the individual reporting training incorporate an independent third party verification which can easily be reported to both potential employers, subcontractors or lead contractors.

Additional indirect benefits might be possible. One example might be possible for insurance premiums to be reduced as third party evidence of safety training might lower some or all insurance costs. Additionally, the third party reporting process can be beneficial in future litigation situations.

It is anticipated that this invention and system will make more individuals, consumers, and entities aware of overall training and education in the workplace and that such awareness may increase the overall safety for all consumers. If this were true, in total or in part, savings to society could be measured in units of ‘lives saved’, ‘dollars’, ‘increase confidence’ and “quality of life” for all consumers. Individuals and consumers should be allowed to know who is up-to-date in safety training if they are placing their fate in other's hands.

### DETAILED DESCRIPTION OF THE INVENTION

Detailed embodiments of the present invention are disclosed herein; however, it is to be understood that the disclosed embodiments are merely illustrations of the invention and that the present invention may be embodied in various forms. In addition, each of the examples given in connection with the various embodiments of the invention is intended to be illustrative, and not restrictive. Further, any example ranking or rating of individuals or entities provided herein may utilize example algorithms or result of algorithms without a full disclosure of such algorithm or algorithms. In addition, all algorithms are considered proprietary and may evolve, change or be modified at any time and in any way.

Therefore, specific structural and functional details disclosed herein are not to be interpreted as limiting, but merely as a representative basis for teaching one skilled in the art to variously employ the present invention. Furthermore, the rating system examples provided herein are for illustrative purposes, which examples are intended to be illustrative and not restrictive, and may or may not represent a current or future rating algorithm, rank or analysis.

Of note, the application contains material that is subject to copyright protection. The copyright owner has no objection to the facsimile reproduction by anyone of the copyrighted material, as it appears in the Patent and Trademark Office file or records, but otherwise reserves all copyright rights whatsoever.

In one embodiment of the present invention there is provided a method of collecting and reporting an individual's education or training activities. The education can be formal schooling such a high school diploma, trade school diploma or certificate, college degree, graduate degrees, safety training, professional continuing education and any trade, industry or professional training or certification. Continuing with this embodiment, the present invention will, in accordance with all current and future legal disclosure requirements and according to the individual's instructions, confirm such training has occurred to certain third parties interested in verifying such activities. Additionally, the present invention will allow verification of what individual and/or entity delivered such education or training and will rate the validity of such trainers and training operations. As one example, (which example is intended to be illustrative and not restrictive), an individual who recently completed a swimming life saving course will be tracked as to a) completion of such course; b) expiration of the course (that is, when the date a refresher course is needed); c) who delivered that course (trainer and training entity) and d) general course content. The result will be to create a confirmation as to successful completion of such course and whether the course was taught by a Registered Nurse with 12 years of experience or a fellow life guard who may graduate high school next year.

In one embodiment of the present invention, an individual's education and training will be independently reported thus allowing portability for said individual. This portability will allow other employers easy access to verification of the training and reported to them by an independent third party.

In one embodiment of the present invention individuals composing an entity (which example is intended to be illustrative and not restrictive) such as a partnership, non-profit company or corporation, not-for-profit company or corporation, or other organization will be aggregated as to completeness of the individual training across all company functions resulting in a rate or ranking for that entity. One illustration (which example is intended to be illustrative and not restrictive) might be a publicly traded corporation in the architectural and engineering business. Professionals will be reviewed for basic educational and training achievements, the present status of required continuing education and any required safety training for employees. In detail, architects may now, or in the future, require a certain amount of professional continuing educational hours per some designated time frame (i.e., 20 hours of professional continuing education every two years). Professional engineers will be tracked as to basic degrees and continuing educational hours. Finance and treasury staff, because this is a public company, will be reviewed for professional degrees, professional designations such as a CPA and continuing educational courses required of this field and industry. Field workers such as in the construction areas require certain OSHA mandated training which will also be tracked. Once compiled a rate and ranking system will be applied indicating an overall performance for the firm; such rate and ranking might be altered as training courses are successfully completed.

### Rank and Rating Examples

Example Set One is comprised of 3 individuals who have supplied information into the collection system incorporated into this invention. Each is designated as a ‘welder’. The rating system for individuals does not rank these individuals but does provide a rating on a scale of 1 to 100.
Welder #1 is given a rating of 85.
   Algorithms for the group of welders have given a high score due to the fact that this individual has had recent and mandatory safety training in the ‘arc weld’ arena; has a diploma from a highly ranked trade school and a higher school diploma as well. Note: the trade school is a ranked entity within this system as well; this allows for the cross-referencing of the trained, the training entity and the trainer.
Welder #2 is given a rating of 70.
   Algorithms for the group of welders have given a relatively low score due no reported mandatory safety training within the last 6 months; however, safety training was reported 18 months ago; additionally, training in the trade was not completed through a recognized entity or individual.
Welder #3 is given a rating of 100.
   Algorithms for the group of welders have given the highest possible score due to recent safety training, recent scuba and deep sea diving training, plasma welding certification (current) and has provided (voluntarily) medical fitness reports indicating the ability for deep underwater assignments.

Example Set Two is comprise of 3 publicly traded companies. Overall rating and company ranking are provided, subject to sufficient data being reported and collect. The examples that follow show three companies in three different industries.
Company #1 is given a rating of 65 and a rank within its peer group of 4 out of 10
   Industry: Petro-Chemical
   Deficits due to
      % of professional engineering degrees from a 4 year institution is extremely low as compared to entire staff.
      # of designated PE's (Professional Engineers as opposed to degreed engineers by not professionally licensed) on staff is extremely low; however, all are current on continuing education courses.
      Worker OSHA requirements are all current; however, team leaders/managers and site managers are not current in safety training
      # of designated CPA in the financial departments is adequate;

however, CE credits for 40% were derived from an unrecognized and invalid Continuing Education provider
No Board Member has reported continuing education courses in ethics and none have any training in corporate governance.
Company #2 is given a rating of 83 and a rank within its peer group of 9 out of 10
   Industry: Residential Construction
   Deficits due to
      Senior Managers have no degrees post secondary schooling in the industrial field.
      # Safety training for all line and site employees up to date; one senior manager is derelict in one safety designation.
      All EPA designations are in place; 50% of staff has completed new regulatory classes taking effect next year.
      80% of Board Members have completed training in corporate governance; 2 newly elected board members have not transferred data
      Documentation for ‘day labor’ and sub-contractors not provided.
Company #1 is given a rating of 51 and a rank within its peer group of 4 out of 10
   Industry: Senior Living
   Deficits due to
      # of professional degrees and advanced degrees spread among the company's facilities indicates too few to cover 24/7 shifts.
      60% of non medical doctor staff have received degrees from accredited institutions, 30% of the RN's and 10% of the LN's have degrees from marginally acceptable educational institutions.
      50% of Senior management in charge of health decisions do not have health degrees or training; 25% have advanced degrees from accredited institutions
      60% of the Board does not have medical industry background; 6 board members sit on 4 or more boards of other companies.

Several Algorithms were used to determine the above examples. Any individual algorithm is subject to change or modification at any time and in response to any trade, industry or governmental regulation enacted over time. There are several methods by which the data can be collected, to include direct communication with individuals, companies and/or through social networks. Similarly, there are several methods by which data such as the rank and ratings can be delivered publicly.

1-3. (canceled)

4. A method to collect and track an individual's mandatory or elected training, education, licensing, certification or any other learned skill set where information such as course completion and passing a training course is provided by the individual and verified by a third party trainer or confirmed by the third party trainer, and monitor and report when such individual is timely, delinquent, or tardy in mandatory training requirements and deadlines.

5. A method to collect, track and report a trainer's qualifications as such qualifications pertain to that trainer's delivery of mandatory, required or elected training, education, licensing, certification or taught skill sets as referenced in claim 4.

6. A method to collect, track and report any organization's collective mandatory, required or elected training, education, licensing, certification or any other learned skills, in aggregate for that organization.

7. A method to collect and track aggregate qualifications, based on individual qualifications outlined in claim 5, for organizations engaged in training activities as such qualifications apply to the delivery of training courses, educational courses, continuing education courses, licensing courses or regulatory courses and rate and rank such organization.

8. A system, which utilizes and evaluates data outlined in claims 4 thru 7, to rate and rank an individual who has taken training courses, to rate and rank any trainer who delivers training or educational courses, and to rate and rank organizations as it pertains to that organization's collective training, as listed in claims 4, 5, 6, and 7.

9. A system which incorporates qualitative, quantitative and/or other analytical tools such as algorithms, statistical measurements and comparative analysis, to include the use of computer hardware and software, used to derive a rank or rating for the individual, the trainer and any organization as listed in claim 8.
